(19) United States
(12) Patent Application Publication
(10) Pub. No.: US 2026/0044359 A1
(43) Pub. Date: Feb. 12, 2026

(54) FUNCTIONAL SAFETY SYSTEM USING SAFETY CERTIFIED REAL-TIME OPERATING SYSTEM AND HYPERVISOR

(71) Applicant: Advanced Micro Devices, Inc., Santa Clara, CA (US)

(72) Inventor: Venkatesh Natarajan, Austin, TX (US)

(73) Assignee: Advanced Micro Devices, Inc., Santa Clara, CA (US)

(21) Appl. No.: 18/795,859

(22) Filed: Aug. 6, 2024

(51) Int. Cl. G06F 9/455

(52) U.S. Cl. CPC G06F 9/45558; G06F 2009/45587

(57) ABSTRACT

An integrated circuit device includes a hardware processor. The integrated circuit device is safety certified. The hardware processor is capable of executing a hypervisor and a real-time operating system (RTOS). The hypervisor is a level 1 hypervisor and is safety certified. The RTOS is safety certified and operates as a first guest machine of the hypervisor. The RTOS is capable of performing a safe operation for a functional safety feature.

### TECHNICAL FIELD

This disclosure relates to functional safety systems that use a safety certified real-time operating system and a hypervisor.

### BACKGROUND

A functional safety system is a system that implements an automated protection response to mitigate, reduce, or possibly eliminate risk relating to another system. Functional safety systems are commonly found in vehicles to protect human operators from injury and/or the vehicle itself from damage. Examples of functional safety systems can include, but are not limited to, an airbag system, a seatbelt or restraining system, and temperature sensors. The functional safety system seeks to provide a predictable response to certain types of inputs, e.g., failures, whether caused by human error, a hardware failure, or other condition.

As an illustrative example, consider an In-Vehicle-Infotainment (IVI) system of an automobile. An IVI system often implements a variety of functional safety features. From time-to-time, the IVI system will display certain safety, or safety critical, data such as a telltale on a display screen within the vehicle. Errors in the display of the telltale must be reliably detected. In the usual case, error detection for a functional safety system involves the use of a dedicated hardware component that has been safety certified. This dedicated hardware component resides external to the IVI system. Any data needed for error checking to ensure that the telltale has been displayed properly, for example, is transmitted from the IVI system (e.g., the component of the IVI system responsible for displaying the telltale) to this dedicated hardware component outside of the IVI system. Thus, the component of the IVI system that displays the telltale and the dedicated hardware component to which the data is transmitted are distinct and discrete parts.

In addition to both of the hardware components being safety certified, the entire signal path linking the two hardware components must be safety certified. The dedicated hardware component performs testing on the data to ensure that such data is error-free and that the functional safety feature has not been compromised.

### SUMMARY

In one or more embodiments, an integrated circuit (IC) device includes a hardware processor capable of executing a hypervisor and a real-time operating system (RTOS). The hypervisor is a level 1 hypervisor and is safety certified. The RTOS is safety certified and operates as a guest machine of the hypervisor. The RTOS is capable of performing a safe operation for a functional safety feature. The IC device is safety certified.

In one or more embodiments, a method is disclosed. The method is implemented in an IC device. The method includes executing, by a hardware processor of the IC device, a hypervisor. The hypervisor is a level 1 hypervisor. The IC device and the hypervisor are safety certified. The method includes executing, by the hardware processor, an RTOS as a guest machine of the hypervisor. The RTOS is safety certified. The method includes performing, by the RTOS, a safe operation for a functional safety feature.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates a system in accordance with one or more embodiments of the disclosed technology.

FIG. 2 illustrates certain operative features of the system of FIG. 1 in accordance with one or more embodiments of the disclosed technology.

FIG. 3 illustrates a method of operation of the system of FIGS. 1 and 2 in accordance with one or more embodiments of the disclosed technology.

FIG. 4 illustrates certain operative features of the system of FIGS. 1 and 2 in accordance with one or more embodiments of the disclosed technology.

FIG. 5 illustrates a method of operation of the system of FIGS. 1 and 2 in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to functional safety systems that use a safety certified real-time operating system and a hypervisor. In accordance with the inventive arrangements described within this disclosure, a framework is provided that is capable of implementing functional safety features or aspects thereof including, for example, safe operations, entirely within a device (e.g., a single device). In one or more embodiments, the safe operations include safety assurance checks and/or verifications of safety assurance checks. The framework may be implemented entirely within an integrated circuit (IC) device. The inventive arrangements are capable of implementing this functionality without the need to send data outside of the device.

The IC device is capable of executing a real-time operating system (RTOS). The RTOS may execute as a guest machine of a hypervisor also executing in the IC device. Each of the IC device, the RTOS, and the hypervisor is safety certified. By utilizing safety certified software components executing within safety certified hardware, various safe operations may be performed entirely within the IC device itself. Data need not be sent to other external components to perform safe operations such as safety assurance checks or verification of results of a safety assurance check.

The ability to implement safe operations completely within a single IC device can significantly reduce latency within the larger system in which the embodiments described herein are implemented or enabled. The inventive arrangements also significantly reduce complexity of a functional safety system as there are no components and no signal paths external to the IC device involved in providing a telltale and/or performing a safety assurance check on the telltale that require functional safety certification.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

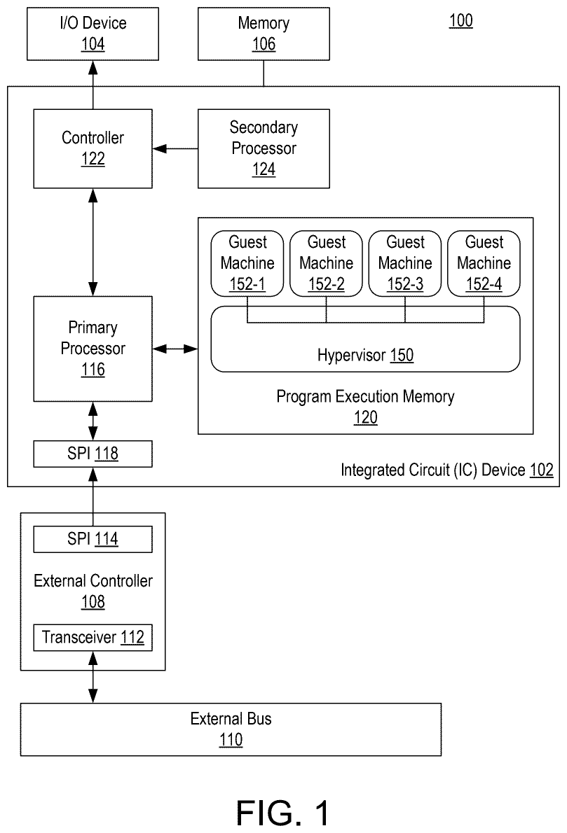

FIG. 1 illustrates a system 100 in accordance with one or more embodiments of the disclosed technology. System 100 is capable of implementing one or more aspects of a functional safety system. In this regard, system 100 may represent all or a portion of a functional safety system as implemented within a larger system. For purposes of illustration, the larger system in which system 100 resides may be a vehicle. The vehicle may be an automobile, an aircraft, a train, or the like. In one or more embodiments, system 100 is part of an “in-vehicle infotainment” or “IVI” system of a vehicle such as an automobile.

An IVI system refers to a system that is capable of providing a user or operator of the vehicle with information pertaining to the operating status of the vehicle and other information such as entertainment. For example, system 100 may provide information by way of one or more input and/or output (I/O) devices. Examples of output devices may include one or more displays (e.g., screens and/or touchscreens), one or more output audio transducers (e.g., speaker(s)), and/or any combination thereof. Examples of input devices may include a touchscreen, a keyboard, one or more physical or actuated buttons or switches, an audio input device (e.g., a microphone), or any combination thereof.

In the example of FIG. 1, system 100 includes an integrated circuit (IC) device 102, one or more I/O devices such as I/O device 104, a memory 106, an external controller 108, and an external bus 110. As shown, IC device 102 is coupled to I/O device 104, memory 106, and external controller 108. IC device 102 is coupled to external bus 110 by way of external controller 108. The combination of IC device 102 and the software components executed by IC device 102 described hereinbelow implements a framework for a virtualized computing environment.

For purposes of illustration, external bus 110 may be implemented as a Controller Area Network (CAN). In the example of FIG. 1, external bus 110 is referred to as “external” in reference to the bus being separate and distinct from IC device 102. Similarly, external controller 108 is referred to as “external” in reference to the controller being separate and distinct from IC device 102. In the example, external controller 108 may be implemented as a CAN controller having a transceiver 112 and a Serial Peripheral Interface (SPI) 114. In one or more embodiments, external controller 108 is also safety certified. External bus 110 also may be safety certified. Though not shown in the example of FIG. 1, one or more sensors and/or other systems may be coupled to external bus 110. Such other sensors and/or systems are capable of detecting particular conditions and submitting messages over external bus 110 indicating the detection of such conditions.

IC device 102 may be implemented as any of a variety of different types of ICs. For example, IC device 102 may be implemented as a System-on-Chip (SoC), an Application-Specific IC (ASIC), an adaptive IC (e.g., a programmable IC such as a Field Programmable Gate Array (FPGA)), an Accelerated Processing Unit (APU), or the like. IC device 102 may include a plurality of different subsystems. An adaptive IC is an IC that may be updated subsequent to deployment of the device into the field. An adaptive IC may be optimized, e.g., configured or reconfigured, for performing particular operations after deployment. The optimization may be performed repeatedly over time to meet different requirements or needs. A programmable IC includes any IC that includes at least some programmable circuitry. Examples of programmable circuitry include programmable logic and/or FPGA circuitry. In one or more embodiments, IC device 102 is implemented as a single die disposed within a single package. In one or more embodiments, IC device 102 may be formed of a plurality of dies or chiplets that are coupled together (e.g., a multi-chip module) and disposed within a single package.

In one or more embodiments, IC device 102 is capable of operating as a self-contained data processing system (e.g., a self-contained computer). In the example of FIG. 1, IC device 102 can include subsystems such as a primary processor 116, an SPI 118, a program execution memory 120, a controller 122, and a secondary processor 124.

Primary processor 116 may be implemented as a central processing unit (CPU) having one or more processor cores. Primary processor 116 is an example of a hardware processor that is implemented as one or more circuits capable of carrying out computer-readable program instructions and/or operations embodied as computer-readable program instructions. In one or more embodiments, primary processor 116 may be implemented using a complex instruction set computer architecture (CISC). An example of primary processor 116 is a hardware processor having an x86 architecture (e.g., IA-32 or IA-64).

It should be appreciated that primary processor 116 may be implemented using other types of processor architectures. In other embodiments, primary processor 116 may be implemented as a reduced instruction set computer architecture (RISC), a vector processing architecture, or other known architecture. In other examples, primary processor 116 may be implemented using a Power Architecture, as an ARM processor, or the like.

Memory 106 may be implemented as a non-volatile memory that is capable of storing firmware for IC device 102. For example, IC device 102 may boot from memory 106 by loading computer-readable program instructions and/or data from memory 106.

Program execution memory 120 may be implemented as a random-access memory (RAM). Program execution memory 120 may be a volatile memory and may be implemented using any of a variety of available RAM technologies (e.g., Double Data Rate, Synchronous Dynamic Random Access Memory (DDR)), High-Bandwidth Memory (HBM) stack, or the like). In the example, program execution memory 120 is illustrated as being on-chip with primary processor 116. In one or more other embodiments, program execution memory 120 is external to IC device 102. In the case where program execution memory 120 is external to IC device 102, program execution memory 120 and circuitry linking program execution memory 120 to primary processor 116 also are safety certified.

In the example of FIG. 1, program execution memory 120 stores a hypervisor 150 and a plurality of guest machines 152 (e.g., 152-1, 152-2, 152-3, and 152-4). For example, such computer readable program instructions may be loaded from memory 106 as part of a boot processor or responsive to another condition. Primary processor 116 is capable of accessing program execution memory 120 and executing the computer-readable program instructions stored therein (e.g., hypervisor 150 and any of guest machines 152-1, 152-2, 152-3, and/or 152-4). The particular number of guest machines stored and/or loaded in program execution memory 120 and/or that are executable by primary processor 116 is not intended to be limited by the particular number and/or example shown. Fewer or more guest machines may be included.

In the example, hypervisor 150 is implemented as a level 1 hypervisor. A level 1 hypervisor is also known as a “bare metal” hypervisor. In this regard, hypervisor 150 may operate directly on primary processor 116. This means that hypervisor 150 does not execute on or require an operating system. Rather, operating systems may be installed as different domains that run on hypervisor 150. Hypervisor 150 provides virtualization functions that allow multiple operating systems to execute as guest machines.

Each guest machine 152-1, 152-2, 152-3, and 152-4 executes on top of hypervisor 150 as a separate and independent domain. Each guest machine 152 may execute independently of the other guest machines such that a failure or compromise of one guest machine does not affect operation of any other guest machine. In one or more embodiments, guest machines 152 may communicate with one another through hypervisor 150. Hypervisor 150 provides virtualization functions for the respective guest machines 152 to access the underlying hardware resources of IC device 102.

In one or more embodiments, guest machine 152-1 may be implemented as a Linux cluster; guest machine 152-2 may be implemented as an RTOS; guest machine 152-3 may be implemented as an infotainment Operating System (OS); and guest machine 152-4 may be implemented as a gaming OS. For purposes of illustration, the Linux cluster may execute one or more Advanced Driver Assistance Systems (ADAS). The RTOS is capable of performing one or more safe operations corresponding to one or more functional safety features described herein in greater detail below. The infotainment OS may be implemented as any of a variety of different mobile operating systems. For example, the infotainment OS may be implemented as Android for inclusion in automobiles enabling communication with Android devices, CarPlay® for communicating with iOS devices, or the like. The infotainment OS is capable of executing an IVI application. The gaming OS may be implemented as any of a variety of different operating systems capable of executing one or more video games. As an example, the gaming OS may be implemented as a version of Linux. In one or more embodiments, the gaming OS may be implemented as Ubuntu Linux. The particular operating system examples provided herein are intended for purposes of illustration. Other operating systems and/or combinations of operating systems may execute as guest machines.

Certain operations performed by IC device 102 are considered safety critical. ISO Standard 26262 defines a risk classification scheme for functional safety known as “Automotive Safety Integrity Level” or “ASIL.” Different levels of risk under ASIL, moving from low risk to high risk, are A, B, C, and D. For example, a both side failure of rear lights is classified as ASIL-A; a both side failure of headlights is classified as ASIL-B; inadvertent braking for radar cruise control is classified as ASIL-C; and inadvertent deployment of the airbag is classified as ASIL-D.

Some functional safety features involve the display of information such as indicator lights, icons, text, or the like. Other functional safety features involve the playing of audio. Such indicators may be the entire response to a particular detected condition or may accompany other actions taken in response to the condition. For example, activation of a low tire pressure indicator is an example response, sometimes referred to as a “telltale” in an IVI system, to a tire pressure sensor detecting air pressure in one or more tires being lower than a defined threshold air pressure. Some telltales may be critical (e.g., ASIL-D) while others are not (e.g., ASIL-A). Within this disclosure, the term “telltale” means an indication provided as part of a functional safety feature and/or within a functional safety system. The telltale may be in any of a variety of different modalities such as visual (e.g., a graphic or graphics) or audio (e.g., a tone, portion of music or other audio, text-to-speech, or recorded audio or verbal message).

In the example of FIG. 1, IC device 102, hypervisor 150, and guest machine 152-2 implemented as an RTOS are implemented as safety certified components. For example, each of IC device 102 (including primary processor 116), hypervisor 150, and the RTOS guest machine may be ASIL certified hardware and/or software components as the case may be. In one or more embodiments, IC device 102 may be entirely safety certified in that each of the circuit blocks therein (e.g., primary processor 116, SPI 118, program execution memory 120, controller 122, and secondary processor 124) is safety certified. In other embodiments, safety certification of IC device 102 means that only those components involved in providing a telltale to an I/O device are safety certified. For example, if IC device 102 includes circuit blocks other than those shown in FIG. 1, such other circuit blocks, if not involved in providing a telltale to I/O device 104, need not be safety certified.

Guest machines 152-1, 152-3, and 152-4 may be implemented as “Quality Management” or QM configured operating systems. QM rated software and/or hardware components refer to components that perform functions associated with a level of risk that is tolerable from a safety perspective and that may be addressed from a customer satisfaction perspective. QM components such as guest machines 152-1, 152-3, and 152-4 are not safety certified.

With respect to those software components that are safety certified such as hypervisor 150 and guest machine 152-2 (e.g., the RTOS), if such software components were not safety certified, execution of such software components on safety certified hardware would not make those software components safety certified or inherently safety certified. That is, for a particular function or operation to be performed and considered a safe operation, the hardware and the software executing on the hardware to perform the operation must be safety certified. As such, the safety certification of IC device 102 or of hypervisor 150 does not render guest machines 152-1, 152-3, and 152-4 safety certified. Such software components must be individually safety certified.

Accordingly, guest machine 152-2 may perform or execute safe operations (also referred to from time-to-time as “safe workloads”) such as safe audio, safe touch (e.g., safe detection of user input), safe camera, cyclic redundancy checks (CRCs), and the like. The safe operations may be executed entirely within IC device 102 without the need for a separate microcontroller to perform such functions. Any operations that are to be safety certified in the IVI may be processed through guest machine 152-2 (e.g., entirely through guest machine 152-2).

Using a mix of guest machines such as QM guest machines (i.e., guest machines 152-1, 152-3, and/or 152-4) to run non-critical functions or functions that do not require safety certified hardware and/or software, and safety certified guest machine(s) such as guest machine 152-2 allows system 100 to execute or run a mix of different functions of different levels of criticality. These different types of operations may be performed using a single device, i.e., IC device 102.

SPI 118 is capable of communicating with SPI 114 of external controller 108. Controller 122 is capable of interacting with and/or controlling one or more I/O devices. In the example of FIG. 1, controller 122 is capable of communicating with I/O device 104. In one or more embodiments, secondary processor 124 may be matched with controller 122 and I/O device 104.

For instance, in an example where I/O device 104 is a display, controller 122 may be implemented as a display controller and secondary processor 124 may be implemented as a graphics processing unit (GPU) or other graphics processor capable of generating image data (e.g., image frames whether for an image or as part of video, where the image frames may include a visual telltale such as an image, an icon, text, or the like). In an example where I/O device 104 is a touch-sensitive display (e.g., a touchscreen), controller 122 may be implemented as a display controller that is also capable of receiving input via the touch-sensitive display and secondary processor 124 may be implemented as a GPU or other graphics processor capable of operating on received inputs as well as generating image data.

In an example where I/O device 104 is an audio output device, controller 122 may be an audio controller and secondary processor 124 may be an audio processor such as a digital signal processor (DSP) capable of generating or playing audio (e.g., an audible telltale such as warning tones, verbal messages whether recorded or generated using text-to-speech, or other audio). In one or more other embodiments, IC device 102 may include multiple controllers 122 and/or multiple secondary processors 124 (e.g., one or more of each audio and/or graphics).

In the example of FIG. 1, only a single I/O device 104 is shown. It should be appreciated, however, that system 100 may include more than one I/O device. For example, system 100 may include one or more displays, one or more touch-sensitive displays, one or more audio output devices, one or more microphones, and/or any combination thereof. It should be appreciated that each such I/O device may have a corresponding controller 122 and/or secondary processor 124. In other examples, multiple I/O devices may be controlled by one controller 122 and one corresponding secondary processor 124.

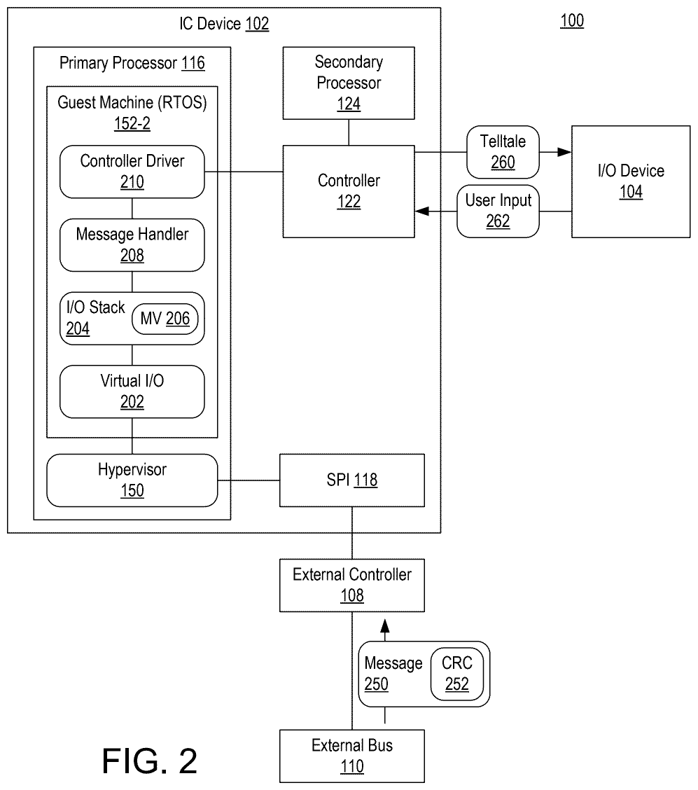

FIG. 2 illustrates certain operative features of system 100 of FIG. 1 in accordance with one or more embodiments of the disclosed technology. More particularly, the example of FIG. 2 illustrates certain operative features of guest machine 152-2 in greater detail. For purposes of illustration, other guest machines are not illustrated. For ease of discussion, guest machine 152-2 may also be referred to herein as “RTOS 152-2.”

In the example, the RTOS corresponding to guest machine 152-2 includes virtual I/O 202, an I/O stack 204, a message handler 208, and a controller driver 210. Virtual I/O 202 is capable of communicating with hypervisor 150 and routing data between RTOS 152-2 (including software components thereof) and hypervisor 150. I/O stack 204 may be implemented as a CAN stack. For example, I/O stack 204 may include a variety of executable software components and/or layers such as one or more CAN drivers, a CAN interface layer, a CAN network management layer, a CAN Transaction Protocol (TP) layer, and a CAN service. I/O stack 204 also may include a message verifier (shown as “MV” in FIG. 2) 206. Message handler 208 is capable of handling messages received from external bus 110. Controller driver 210 is capable of communicating with controller 122. In one or more embodiments, RTOS 152-2 owns SPI 118.

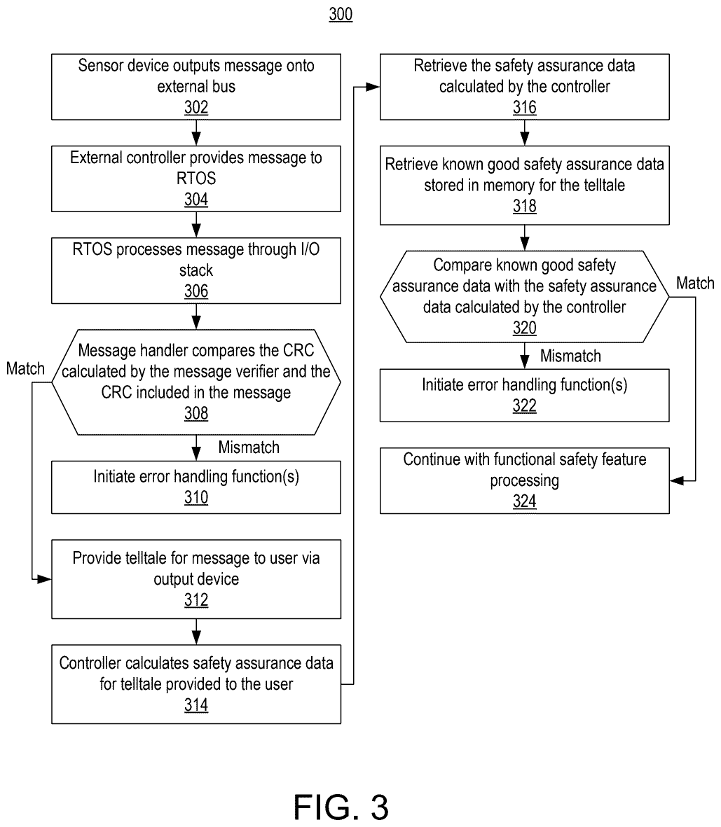

FIG. 3 illustrates a method 300 of operation of system 100 of FIGS. 1 and 2 in accordance with one or more embodiments of the disclosed technology. In the example of FIG. 3, the system of FIGS. 1 and 2 may be operating within a vehicle such as an automobile as part of an IVI system.

Referring to FIGS. 1, 2, and 3, in block 302, a sensor device such as an electronic control unit coupled to external bus 110 outputs a message 250 on external bus 110. For example, the sensor device may detect a particular condition within the vehicle that, per a functional safety feature of the vehicle, requires a response. The message 250 may be an instruction or command to provide a particular indication of a condition (e.g., a telltale) in the vehicle via the IVI system. The message may be directed to RTOS 152-2.

In block 304, external controller 108 provides message 250 to RTOS 152-2. For example, external controller 108 receives message 250 on external bus 110 and provides message 250 to IC device 102 via SPI 114 and SPI 118. As RTOS 152-2 owns SPI 118, message 250 is provided to primary processor 116 executing hypervisor 150 and RTOS 152-2.

In block 306, RTOS 152-2 processes message 250 through I/O stack 204. For example, message 250 is routed to I/O stack 204 by way of virtual I/O 202. As part of block 306, message verifier 206 is capable of calculating a CRC for message 250 as received by RTOS 152-2. Message 250, as illustrated in FIG. 2, also includes a CRC 252 therein as conveyed to RTOS 152-2. That is, the particular sensor device that generated message 250 included CRC 252 therein.

In block 308, message handler 208 compares the CRC calculated by message verifier 206 with CRC 252 contained in message 250 to ensure the two CRCs match. In response to detecting that CRC 252 does not match the CRC calculated by message handler 208, method 300 continues to block 310 to initiate one or more error handling functions. The error handling function(s) may be specific to the particular system (e.g., vehicle) in which system 100 is implemented and specific to the particular functional safety feature being implemented. In response to detecting that CRC 252 matches the CRC calculated by message handler 208, method 300 continues to block 312.

In block 312, a telltale 260 associated with message 250 is provided to the user via an output device such as I/O device 104. For example, message handler 208 is capable of notifying controller driver 210 of the match between the two CRCs. In response thereto, controller driver 210 is capable of instructing controller 122 to provide telltale 260 to the user via I/O device 104.

For example, in the case where telltale 260 is a visual telltale (e.g., image data such as a graphic, text, icon, or other visual data), secondary processor 124, which may be a GPU in this example, is capable of generating an image frame including telltale 260 and providing the image frame including telltale 260 to controller 122. Controller 122 conveys the image frame including telltale 260 to I/O device 104 for display by I/O device 104.

In one or more embodiments, secondary processor 124, operating under control of controller 122, generates one or more image frames that may be displayed on I/O device 104 statically or as video. While the condition detected for the functional safety feature persists, the image frames generated by secondary processor 124 may include telltale 260 placed at a particular location (e.g., with known pixel coordinates) in each image frame. In a typical IVI system, I/O device 104 may be capable of displaying frames at a rate of approximately 60 frames per second. Some systems may have higher frame rates while others may have lower frame rates. Telltale 260 may occupy a same region of each image frame such that the set of pixels specifying telltale 260 is known for each image frame generated.

In the case where telltale 260 is an audible telltale (e.g., audio data), secondary processor 124, which may be a DSP in this example, is capable of generating telltale 260. If other audio data is being played, such other audio may be discontinued and/or mixed together with telltale 260 depending on the particular functional safety feature being implemented and the condition detected. Secondary processor 124 is capable of providing telltale 260 to controller 122. Controller 122 conveys telltale 260, e.g., audio data, to I/O device 104 for playing by I/O device 104.

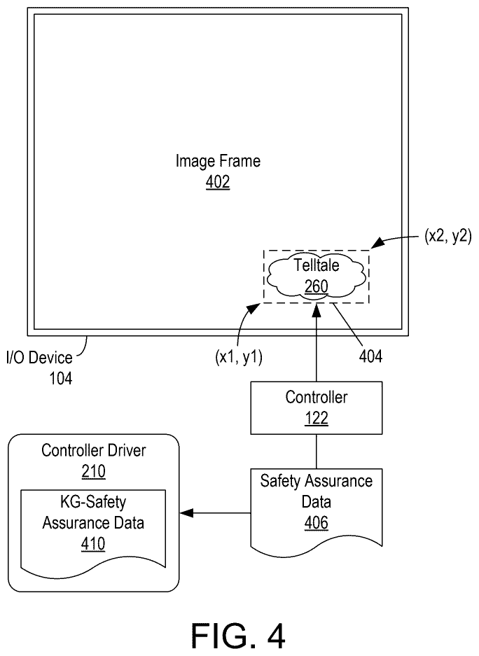

In block 314, controller 122 calculates safety assurance data for telltale 260. In one or more embodiments, controller driver 210 instructs controller 122 to calculate safety assurance data for telltale 260. In the example where telltale 260 is a visual telltale, controller 122 is aware of the region of the image frame currently displayed by I/O device 104 that includes telltale 260. Referring to FIG. 4, for example, an image frame 402 is displayed by I/O device 104. As the location of telltale 260 within image frame 402 is predetermined and known, controller 122 knows the coordinates (x1, y1) and (x2, y2) that define a bounding box 404 encompassing or surrounding telltale 260 as displayed on I/O device 104. Controller 122 is capable of calculating a CRC for the region of frame 402 defined by, e.g., encompassed by, bounding box 404. In this example, the safety assurance data 406 is a CRC. The safety assurance data 406 is calculated using the frame or image data including the telltale as received from secondary processor 210, for example, prior to controller 122 conveying such data to I/O device 104. Typically, the path from controller 122 to I/O device 104 is safety certified and considered safe.

In the case where telltale 260 is an audible telltale, controller 122 may generate safety assurance data 406 based on the audio data that is played. In that case, the safety assurance data 406 may be a CRC calculated based on the audio data (e.g., telltale 260) as received from secondary processor 210 prior to conveyance of the audio data to I/O device 104.

In block 316, controller driver 210 retrieves safety assurance data 406 as calculated by controller 122. In this example, controller driver 210 retrieves the CRC calculated by controller 122 for telltale 260. In block 318, controller driver 210 retrieves a known good safety assurance data 410 stored in memory. Known good safety assurance data 410 is specifically for telltale 260. For example, known good safety assurance data 410 may be a known good CRC.

In one or more embodiments, controller driver 210 may maintain, or include, a lookup table of known good safety assurance data (e.g., CRCs in these examples) with indexes allowing controller driver 210 to retrieve the correct known good safety assurance data for purposes of comparison with safety assurance data 406. In one or more embodiments, controller driver 210 may index into the lookup table based on an identifier of message 250 as received, based on the known coordinates of telltale 260 as displayed in image frame 402, or using another indexing technique.

In block 320, controller driver 210 is capable of comparing known good safety assurance data 410 stored in memory for telltale 260 with safety assurance data 406 calculated by, and retrieved from, controller 122. The comparing of known good safety assurance data 410 with safety assurance data 406 may be referred to herein as a verification operation or as verification. In response to detecting that safety assurance data 406 does not match known good safety assurance data 410, method 300 is capable of continuing to block 322 to initiate one or more error handling functions. The error handling function(s) may be specific to the particular system (e.g., vehicle) in which system 100 is implemented and specific to the particular functional safety feature being implemented. In response to detecting that safety assurance data 406 does match known good safety assurance data 410, method 300 continues to block 324. In block 324, method 300 continues with functional safety feature processing. For example, telltale 260 may continue to be provided while the condition detected by the sensor device in block 302 persists.

In one or more embodiments, in the case where telltale 260 is image data, the operations described in connection with blocks 312-320 may be performed one time for each of N different image frames. For example, for each of a plurality of image frames, e.g., N where N is an integer greater than 1, controller 122 may display the image frame, perform the safety assurance check on the telltale of the image frame, provide the safety assurance data to the RTOS, and the RTOS verify the safety assurance data by comparing the received safety assurance data with the known good safety assurance data. As an illustrative and non-limiting example, N may be set to three. Accordingly, for three different image frames in which telltale 260 is included, the aforementioned operations may be performed. In one or more embodiments, the verification need only fail one of the N times to initiate the error handling of block 322. In one or more embodiments, the verification may need to fail each of the N times or a minimum number of the N times in order to initiate the error handling of block 322.

In one or more embodiments, in block 324, the result of the verification operation performed in block 320 may be output and/or provided to another system.

In one or more other embodiments, safety assurance data 410 may be generated by controller 122 and compared by RTOS 152-2 with the known good safety assurance data 410 prior to providing the telltale to the user via the output device. In such embodiments, the detection of a mismatch as described in connection with block 320 prevents what is determined to be a corrupted telltale from being provided to the user via the output device or permits such a response depending on the error handling function(s) implemented.

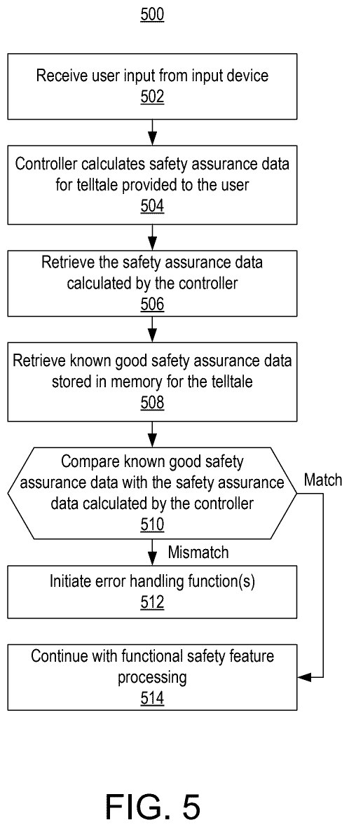

FIG. 5 illustrates a method 500 of operation of system 100 of FIGS. 1 and 2 in accordance with one or more embodiments of the disclosed technology. In the example of FIG. 5, the system of FIGS. 1 and 2 may be operating within a vehicle such as an automobile as part of an IVI system. Referring to FIGS. 1, 2, and 5, in block 502 a user input 262 is received from an input device such as I/O device 104. The user input may be a touch user input received via a touchscreen or the like.

In block 504, controller 122 calculates safety assurance data for user input 262. In the example where user input 262 is specified as touch data generated in response to a detected touch of a touch-sensitive display, controller 122 is aware of the region of the touchscreen in which the touch is detected. Controller 122, for example, may have information such as the size and shape of the detected touch, the pressure of the touch, and the length of time that the touch was detected among other potential information provided from the touchscreen. Controller 122 is capable of generating safety assurance data based on the touch data.

In block 506, controller driver 210 retrieves the safety assurance data as calculated by controller 122 for user input 262. In block 508, controller driver 210 retrieves a known good safety assurance data stored in memory corresponding to the type of user input that is received (e.g., user touch). Known good safety assurance data in this example is specifically for user input 262. Controller driver 210 may retrieve the correct known good safety assurance data from memory using any of the techniques described in connection with FIGS. 3 and/or 4.

In block 510, controller driver 210 is capable of comparing known good safety assurance data stored in memory for user input 262 with the safety assurance data calculated by, and retrieved from, controller 122. The verification operation performed in block 510 may be used to verify that user input 262 is a valid user input. For example, the verification may ensure that a detected touch (user input 262) was not an accidental touch by ensuring that the touch data of user input 262 matches a profile (e.g., known good safety assurance data) of an intentional touch rather than an accidental touch or a detected touch from an object other than a user's finger.

In one or more embodiments, the safety assurance data generated may be a CRC calculated based on the touch data with the known good safety assurance data being a CRC of an underlying type of data (e.g., a CRC of a known good touch profile).

In response to detecting that the safety assurance data does not match the known good safety assurance data, method 500 is capable of continuing to block 512 to initiate one or more error handling function(s). The error handling functions may be specific to the particular system (e.g., vehicle) in which system 100 is implemented and specific to the particular functional safety feature being implemented. In response to detecting that safety assurance data does match the known good safety assurance data, method 500 continues to block 514. In block 514, method 500 continues with functional safety feature processing. In one or more embodiments, in block 514, the result of the verification operation performed in block 510 may be output and/or provided to another system.

With reference to FIGS. 3 and 5, the particular operations described such as the generation of safety assurance data and/or the verification of the safety assurance data by way of comparing the safety assurance data with known good safety assurance data, are examples of safe operations.

In one or more embodiments, the telltales may be provided through a different guest machine 152 than the safety certified RTOS. For example, the telltales, whether visual telltales or audible telltales, may be provided to the user via a guest machine 152 such as 152-1 (e.g., Linux) or 152-3 (e.g., the infotainment OS). In that case, while the safety certified RTOS does not initially provide the telltale to the user, the RTOS still may be used for purposes of verifying the safety assurance data. For example, in the case where guest machine 152-1 displays the telltale, controller 122 is capable of providing a notification that the telltale is displayed (e.g., a frame) using an interrupt to guest machine 152-2. In response to the interrupt, RTOS 152-2 is capable of reading the CRC from controller 122 and performing the verification related operations already described comparing the read CRC from controller 122 with the known good CRC.

In one or more embodiments, controller 122 may operate primarily or mainly in guest machine 152-1 despite being safety certified. In such embodiments, the device drivers (e.g., the display drivers) of guest machine 152-1 may be QM and not safety certified. Still, the verification described above is performed via guest machine 152-2.

In one or more embodiments, hypervisor 150 may be configured to provide duplicate injection of interrupts to two or more guest machines. That is, certain interrupts provided from hypervisor 150 to a selected guest machine 152 may be provided to one or more other guest machines simultaneously or concurrently. For purposes of illustration, consider the example in which guest machine 152-1 performs functions such as displaying image data specifying gauges (e.g., a speedometer) on a display screen and also outputs a telltale as image data to a display screen while guest machine 152-2 performs the verification of the telltale.

In that case, hypervisor 150 is capable of generating a pair of interrupts. Hypervisor 150 directs or provides a first interrupt of the pair of interrupts to a first guest machine such as guest machine 152-2 and a second interrupt of the pair of interrupts to a second guest machine such as guest machine 152-1. For purposes of illustration, hypervisor 150 is capable of generating and injecting an interrupt (e.g., a “sync” interrupt) to each of guest machines 152-1 and 152-2 simultaneously (e.g., concurrently) or with one immediately following the other. In this example, the interrupts provided to two or more guest machines as described may be owned by each respective guest machine into which the interrupt is injected by hypervisor 150. For example, in response to the interrupt received by guest machine 152-1, guest machine 152-1 instructs controller 122 to display a frame or image data including a telltale. In response to the interrupt received by guest machine 152-2, guest machine 152-2 reads the safety assurance data 406 generated by controller 122 as previously described for the telltale and proceeds with the verification of the safety assurance data 406 by comparing safety assurance data 406 with the known-good safety assurance data 410.

Thus, in one or more embodiments, guest machine 152-2 both provides the telltale to the user via I/O device 104 and performs verification of the safety assurance data 406. In one or more other embodiments, another guest machine such as guest machine 152-1 provides the telltale to the user via I/O device 104 (which may involve one more QM processes), while guest machine 152-2 reads the safety assurance data 406 and performs verification of the safety assurance data 406.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like. Memory 106 and program execution memory 120 are examples of computer readable storage mediums.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in computer-readable program instructions (e.g., program code). The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process. An RTOS is capable of processing events and/or responding to events in real-time.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the term “program code” may be used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An integrated circuit device, comprising:
a hardware processor capable of executing:
a hypervisor, wherein the hypervisor is a level 1 hypervisor and is safety certified; and
a real-time operating system (RTOS), wherein the RTOS is safety certified and operates as a first guest machine of the hypervisor;
wherein the RTOS is capable of performing a safe operation for a functional safety feature; and
wherein the integrated circuit device is safety certified.

2. The integrated circuit device of claim 1, wherein the hardware processor is capable of executing:
an additional operating system as a second guest machine of the hypervisor, wherein the additional operating system is configured for a Quality Management operation.

3. The integrated circuit device of claim 2, wherein the first guest machine and the second guest machine are capable of communicating with one another via the hypervisor.

4. The integrated circuit device of claim 2, wherein the hypervisor is capable of generating a pair of interrupts, wherein a first interrupt of the pair of interrupts is directed to the first guest machine and a second interrupt of the pair of interrupts is directed to the second guest machine.

5. The integrated circuit device of claim 1, further comprising:
a circuit block that is safety certified and capable of providing a telltale to an output device.

6. The integrated circuit device of claim 5, further comprising:
signal path circuitry coupling the hardware processor and the circuit block, wherein the signal path circuitry is safety certified.

7. The integrated circuit device of claim 6, wherein the circuit block is capable of generating safety assurance data by performing a safety assurance check on the telltale and providing the safety assurance data to the RTOS; and
wherein the safe operation includes the RTOS comparing the safety assurance data generated by the circuit block with known good safety assurance data.

8. The integrated circuit device of claim 5, wherein the telltale is a visual telltale.

9. The integrated circuit device of claim 5, wherein the telltale is an audible telltale.

10. The integrated circuit device of claim 1, further comprising:
a circuit block capable of:
receiving a user input from an input device;
generating safety assurance data by performing a safety assurance check on the user input; and
providing the safety assurance data to the RTOS for verification; and
wherein the safe operation includes the RTOS comparing the safety assurance data generated by the circuit block with known good safety assurance data.

11. A method implemented by an integrated circuit device, the method comprising:
executing, by a hardware processor of the integrated circuit device, a hypervisor, wherein the hypervisor is a level 1 hypervisor and is safety certified;
executing, by the hardware processor, a real-time operating system (RTOS) as a first guest machine of the hypervisor, wherein the RTOS is safety certified; and
performing, by the RTOS, a safe operation for a functional safety feature.

12. The method of claim 11, further comprising:
executing an additional operating system as a second guest machine of the hypervisor, wherein the additional operating system is configured for a Quality Management operation.

13. The method of claim 12, wherein the first guest machine and the second guest machine are capable of communicating with one another via the hypervisor.

14. The method of claim 12, wherein the hypervisor is capable of generating a pair of interrupts, wherein a first interrupt of the pair of interrupts is directed to the first guest machine and a second interrupt of the pair of interrupts is directed to the second guest machine.

15. The method of claim 11, further comprising:
providing, from a circuit block of the integrated circuit device, a telltale to an output device, wherein the circuit block is safety certified.

16. The method of claim 15, further comprising:
generating safety assurance data by the circuit block by performing a safety assurance check on the telltale; and
providing the safety assurance data to the RTOS for verification.

17. The method of claim 16, further comprising:
comparing, within the RTOS, the safety assurance data generated by the circuit block with known good safety assurance data.

18. The method of claim 15, wherein the telltale is a visual telltale.

19. The method of claim 15, wherein the telltale is an audible telltale.

20. The method of claim 11, further comprising:
receiving, by a circuit block of the integrated circuit device, a user input from an input device;
generating safety assurance data by the circuit block by performing a safety assurance check on the user input;
providing the safety assurance data to the RTOS for verification; and
comparing, within the RTOS, the safety assurance data generated by the circuit block with known good safety assurance data.
